(19) United States
(12) Patent Application Publication
(10) Pub. No.: US 2009/0236050 A1
(43) Pub. Date: Sep. 24, 2009

(54) WINDOW COVERING

(76) Inventor: Tony Marzilli, Mississauga (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/053,918

(22) Filed: Mar. 24, 2008

(51) Int. Cl. E06B 9/40

(52) U.S. Cl. 160/241

(57) ABSTRACT

An window covering is disclosed. The window covering comprises a first roller and a spaced apart second roller mounted in a window frame. A first sheet is connected to the first roller at its trailing edge and a second sheet is connected to the second roller at its trailing edge. Each flexible sheet is movable from a stowed position, where it is coiled around a corresponding roller to a deployed position where it is drawn away from the roller to cover the window. The rollers bias the sheets toward the stowed position. The leading edges of the sheets may be removably connectable so that, when deployed together, the sheets cover the window between the rollers and resist being pulled into the stowed position. At least a portion of the first sheet permits more light to pass through than the second sheet.

### FIELD OF THE INVENTION

The invention relates to window coverings. More specifically, the invention relates to adjustable window coverings having sheets with different light transmitting properties.

### BACKGROUND OF THE INVENTION

There exist many types of window coverings. Window coverings are used for a variety of purposes, such as privacy or shade. One known type of window covering is a roller blind which typically includes an opaque or translucent flexible sheet of material. Such roller blinds only permit the user to permit all the light to pass through (by raising the blind) or to cover the window with the flexible sheet, thereby reducing or eliminating the transmission of light through the window.

### SUMMARY OF THE INVENTION

The embodiments described herein provide in one aspect a window covering for a window having a frame. The window covering comprises:

a first roller and a spaced-apart second roller, where the first and second rollers are rotatably mounted to the frame;

a first sheet connected to the first roller and a second sheet connected to the second roller, where each of the first and second sheets comprises a pair of opposing side edges, a trailing edge and a leading edge; the trailing edge being secured to the corresponding roller;

wherein first and second sheets are each movable between a stowed position and a deployed position, wherein the first and second sheets are coiled around the corresponding roller in the stowed position, wherein the leading edge is extended away from the corresponding roller in the deployed position;

wherein the first and second rollers are each adapted to bias the corresponding sheet in the stowed position;

wherein the leading edge of the first sheet and the leading edge of the second sheet are adapted to make a removable connection therebetween to maintain the first and second sheets in the deployed position;

wherein at least a portion of the first sheet is adapted to permit more light to pass therethrough than the second sheet.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is an exploded perspective view of a first embodiment of a window covering according to the present invention;

FIG. 2 is an exploded perspective view of a second embodiment of a window covering according to the present invention;

FIG. 3. is a perspective view of the second embodiment showing two different types of flexible sheets;

FIG. 4. is a perspective view of the second embodiment showing one of the sheets covering the entire window; and

FIG. 5. is a perspective view of the second embodiment showing yet another different set of two sheets.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

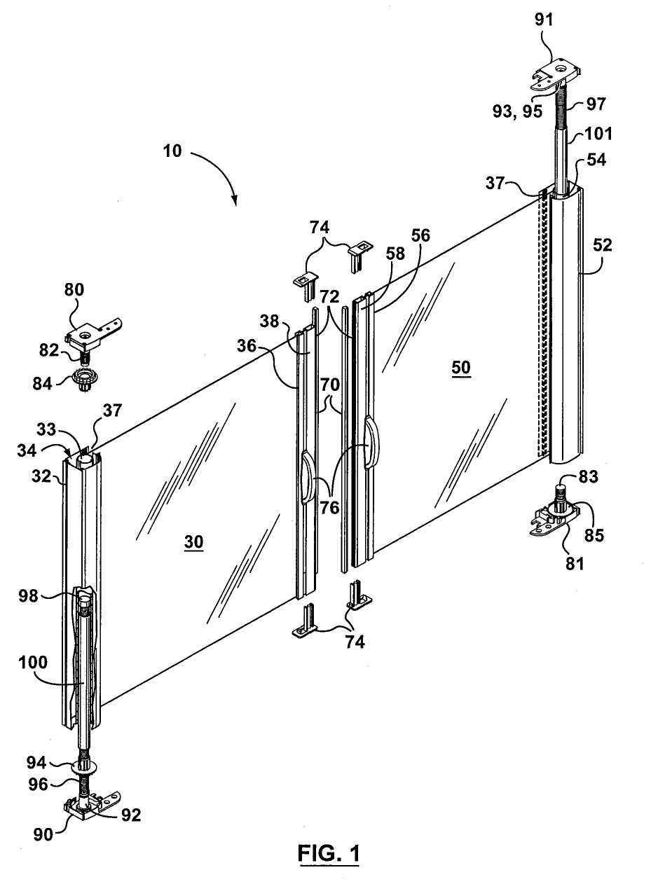

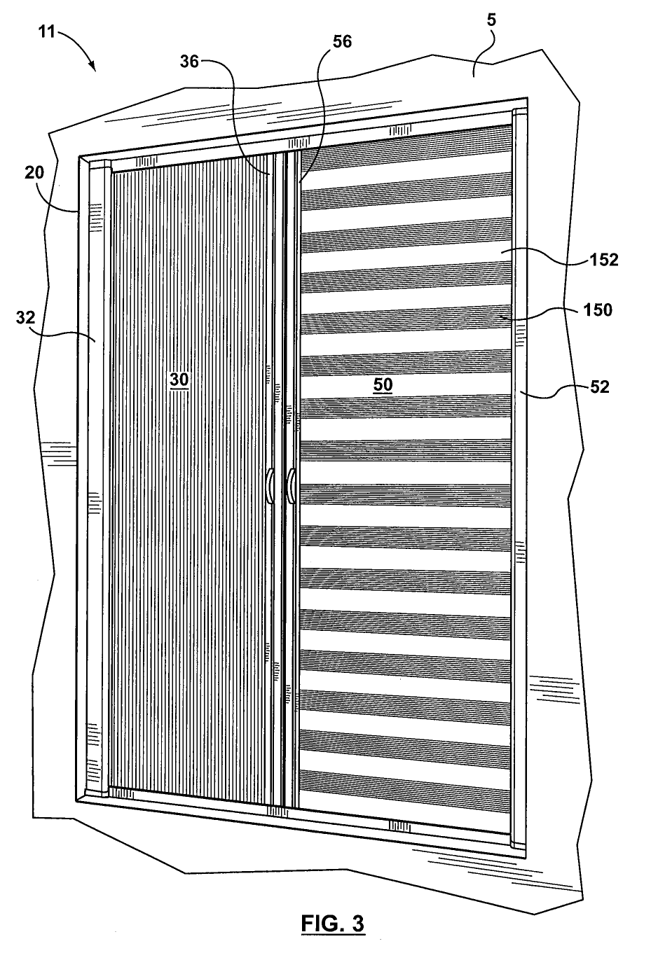

FIG. 1 shows a window covering 10 according to an embodiment of the present invention. The window covering 10 includes a first preferably flexible sheet 30, rolled onto a first roller 34 that is mounted to a window frame 20 (shown in FIG. 3) by mounts 80, 90 connected to opposing ends of the first roller 34. The first roller 34 is adapted to bias the first flexible sheet 30 into a stowed position where the first flexible sheet 30 is coiled around the first roller 34. The leading edge 36 of the first flexible sheet 30 may be extended away from the first roller 34 to bring the first flexible sheet 30 into a deployed position. A second preferably flexible sheet 50 is likewise connected to a second roller 54 that is also mounted to the frame (not shown) using mounts 81, 91 (preferably identical to mounts 80, 90). The second roller 54 is mounted in the window at a distance spaced apart from the first roller 34. Preferably, the first and second rollers 34, 54 are located at opposing ends of the window.

The second roller 54 is adapted to bias the second flexible sheet 50 into a stowed position where the second flexible sheet 50 is coiled around the second roller 54. Likewise, the leading edge 56 of the second flexible sheet 50 may be extended away from the second roller 54 to bring the second flexible sheet 50 into a deployed position. Further, the leading edge 36 of the first flexible sheet 30 and the leading edge 56 of the second flexible sheet 50 are adapted to make a removable connection therebetween, holding the first flexible sheet 30 and the second flexible sheet 50 in the deployed position.

The first flexible sheet 30 and second flexible sheet 50 have different light transmitting properties. The first flexible sheet 30 and the second flexible sheet 50 may each be composed of a plastic material or fabric and may exhibit any combination of transparency and translucency, from completely transparent and translucent to completely opaque. The first flexible sheet 30 and the second flexible sheet 50 may each comprise more than one type of material with more than one set of light transmitting properties.

As used in this application, translucency refers to the amount of light allowed to pass through so that a high degree of translucency refers to allowing a large fraction of incoming light to pass through the flexible sheet. As used in this application, transparency refers to the amount of distortion of light as it passes through a flexible sheet so that a high degree of transparency refers to a low degree of distortion: i.e. the user can see clearly through the sheet.

For example, as shown in FIG. 3, the first sheet 30 may be composed of an opaque material, such as fabric, which blocks light and provides privacy. The second sheet 50 is composed of alternating horizontal strips of an opaque material 150 (preferably identical to the material in the first sheet 30), and a transparent plastic material 152. This configuration of second sheet 50 reduces the light passing through the window and provides some privacy while permitting the user to see out the window.

In addition, the first roller 34, the first sheet 30, the second roller 54 and the second flexible sheet 50 may be dimensioned so that when the leading edge 36 of the first sheet 30 is connected to the leading edge 56 of the second flexible sheet 50, substantially all of the window between the first roller 34 and the second roller 54 is covered.

Further, the first roller 34 and the first sheet 30 may be dimensioned so that the first sheet 30, when fully unrolled, is capable of covering substantially the entirety of the window. The second roller 54 and the second sheet 50 may be dimensioned so that the second flexible sheet 50, when fully unrolled, is capable of covering substantially the entirety of the window. Alternatively, the first roller 34, the first sheet 30, the second roller 54 and the second sheet 50 may be dimensioned so that both the first sheet 30 and the second sheet 50 are capable of covering substantially the entirety of the window alone. In this embodiment, the leading edge 36 of the first sheet 30 and the leading edge 56 of the second sheet 50 may be drawn together and connected so that the first sheet 30 together with the second sheet 50 covers substantially all of the window between the first roller 34 and the second roller 54. Additionally, when both the first sheet 30 and the second sheet 50 are capable of covering substantially all of the window between the rollers alone, the user may position the connecting point anywhere between the first roller 34 and the second roller 54 so as to permit the user to set the proportion of the window between the rollers being covered by the first sheet 30 and the second sheet 50.

Referring again to FIG. 1, the first roller 34 and the second roller 54 are rotatably mounted to the frame 20. The operation of the first roller 34 will now be described. Preferably, the configuration of the second roller 54 is identical to the first roller 34. Specifically, parts 80, 82, 84, 90, 92, 94, 96, 98 and 100 associated with the first roller 34 are equivalent to parts 81, 83, 85, 91, 93, 95, 97, 99 and 101 associated with the second roller 54.

First mount 80 is secured to the window frame 20 in any suitable fashion. Mount 80 includes a first spindle 82 projecting downwardly. Collar 84 fits over first spindle 82 and is free to rotate about first spindle 82. A first end 33 of first roller 34 fits snuggly over collar 84. Second mount 90 is secured to the frame 20 and includes a second spindle 92 projecting upwardly. Collar 94 fits over second spindle 92 and is free to rotate about spindle 92. A second end of first roller 34 fits snuggly over collar 94.

The first roller 34 is adapted to bias the first flexible 30 into the stowed position where the first sheet 30 is coiled around the first roller 34. The second roller 54 is adapted to bias the second sheet 50 into the stowed position where the second sheet 50 is coiled around the second roller 54. Preferably, both rollers 34, 54 use a spring 96 to bias the first and second sheets 34, 50 into the stowed position.

Referring to FIG. 1, the spring 96 is connected in any suitable fashion to the spindle 92 in such a way so as not to interfere with the rotation of collar 94 about the spindle 92. For example, the spindle 92 may be constructed so as to extend through the collar 94 so that the spring 96 may be connected, using for example a press fit, to the extended portion of the spindle 92.

The spring 96 extends into the first roller 34 and is connected to the inside surface of the first roller in any suitable fashion. For example, a plug 98 may be provided that fits snuggly inside the first roller 34 while the spring 96 is connected to the plug 98, for example using a press fit. As an alternative example, the plug 98 may interface with a groove or ridge on the inside of the first roller 34. As the first sheet 30 is drawn out into the deployed position, the tension in the spring 96 increases and imparts a rotational force on the first roller 34 such that it pulls the first sheet 30 toward the stowed position. Optionally, the spring 96 may be pre-tensioned in order to increase the force on the first sheet 30. In addition, a spring tube 100, of nominally greater diameter than the spring 96, may also be provided in order to prevent the spring from flexing in a radial direction.

The first roller 34 may be contained within a first cassette 32 and the second roller 54 may be contained within a second cassette 52. The first cassette 32 and the second cassette 52 preferably serve to provide a clean and finished appearance to the window covering 10 according to the first embodiment. The cassettes may also include slits 37 to prevent the first flexible sheet 30 and the second flexible sheet 50 from being completely pulled into the stowed position, thus keeping the leading edges 36, 56 accessible for the user's grasp.

The leading edge 36 of the first sheet 30 and the leading edge 56 of the second sheet 50 are adapted to make a removable connection therebetween, holding the first flexible sheet 30 and the second flexible sheet 50 in the deployed position. Any suitable manner of making a removable connection may be used, such as for example, buttons, snaps, laces, clamps, hook and loop fasteners or magnets.

Preferably, a first header 38 connected to the leading edge 36 of the first sheet 30 and a second header 58 connected to the leading edge 56 of the second sheet 50 are provided. Preferably, each header includes a magnetic strip 70 of opposing polarity (or one magnetic strip and another metal strip which is attracted to a magnet) so that the headers are attracted to each other. This permits a removable connection to be formed between the first header 38 and the second header 58 when they are brought in close proximity. In the embodiment shown in FIG. 1, the magnetic strips 70 fit into a slot 72 on the ends of the headers. End caps 74 may be mounted on the ends of the headers 38, 58 to keep the magnetic strip in place and protect the user from rough edges. A handle 76 is connected to each header 38, 58 to allow the user to more easily grasp the headers 38, 58.

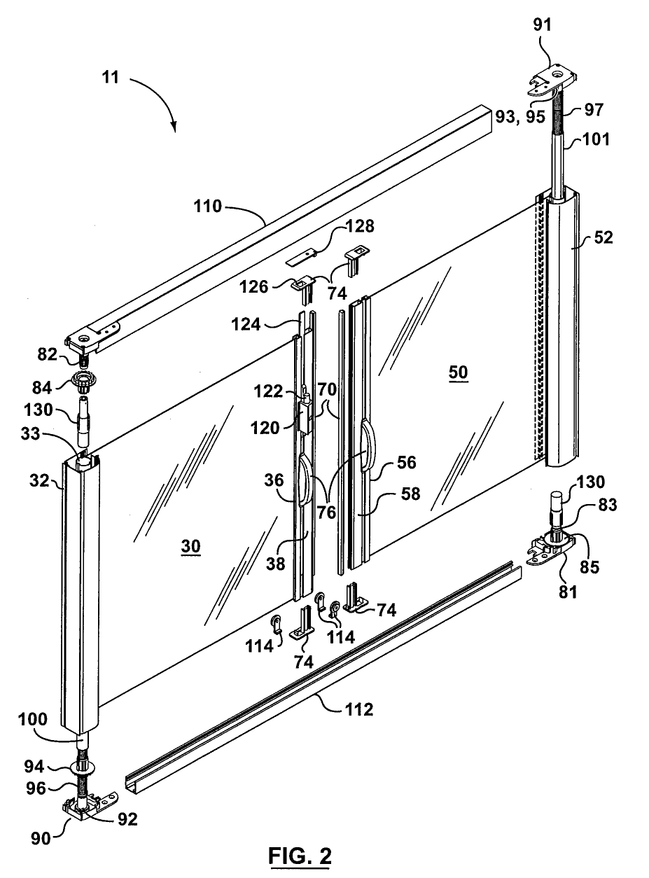

FIG. 2 shows a second embodiment 11 of the window covering. Similar parts to those shown in FIG. 1 are assigned similar part numbers and will not be further described. This embodiment further comprises upper and lower guide rails 110, 112, wheels 114, a lock 120 and decelerators 130. The guide rails 110, 112 guide the flexible sheets 30, 50. The wheels 114 allow the first header 38 to move more easily in the guide rails. The lock 120 locks the flexible sheets into a desired configuration. The decelerators 130 attenuate the force of the springs 96, 97.

The upper and lower guide rails 110, 112 guide the first flexible sheet 30 and the second flexible sheet 50 in transitioning from the stowed position to the deployed position. The guide rails also guide the first header 38 and the second header 58 when being connected. The guide rails 110, 112 may have a substantially U-shaped cross-section which receives the headers 38, 58 and the flexible sheets 30, 50. The guide rails 110, 112 may be secured to the mounts 80, 81, 90, 91 or may be mounted directly to the frame 20 in any suitable fashion, such as using fasteners.

The window covering 11 according to the second embodiment may include wheels 114 connected to both ends of the headers 38, 58. The wheels 114 engage with the guide rails 110, 112 in any suitable manner in order to ease the movement of the first header 38, the first flexible sheet 30, the second header 58 and the second sheet 50 while transitioning from the stowed position to the deployed position.

The window covering 11 may also comprise a lock 120, connected to the first header 38, for locking the first flexible sheet 30 into place. Preferably, the lock 120 includes an actuator, such as button 122, which when operated by a user, causes a rod 124 to project vertically through a hole 126 in the end cap 74 to engage with a stop 128 that is secured to the upper guide rail 110. The stop engages with the rod 124 to lock the first sheet 30 into place. The second sheet 50 may also be locked into place simultaneously when it is secured to the first flexible sheet 30 in the manner described above.

In an alternative embodiment (not shown), the lock 120 may further comprise a second rod extending vertically downward through a hole in the end cap 74 to engage with a stop that is secured to the bottom guide rail 112. The second rod may be extended using the same button 122 as the rod 124 or using a different actuator.

In another alternative embodiment (not shown), the window covering 11 may further comprise a second lock connected to the second header 58 for locking the second sheet 50 into place. In this embodiment, both sheets may be locked into place independently, possibly leaving a gap of uncovered window between the leading edge 36 of the first flexible sheet 30 and the leading edge 56 of the second sheet 50.

Referring again to FIG. 2, the window covering 11 according to the second embodiment may also comprise decelerators 130 coupled to the first roller and the second roller 34, 54. The decelerator 130 is used to attenuate the force applied to each of the rollers 34, 54 by the spring 96 so as to reduce the acceleration of the sheets 30, 50 from the deployed position back to the stowed position. The further the leading edge of the each sheet is drawn from the corresponding roller, the greater the return force applied by the spring 96. This force can be significant. If a user accidentally releases the sheet when it is in the deployed position, the sheet may snap back with a force that could create a risk of injury or at least startle the user. The decelerator 130 attenuates the force applied to each roller in order to slow the return of each sheet to the stowed position.

One end of the decelerator 130 is connected to the spindle 82 so as not to interfere with the collar's 84 rotation about the spindle 82, for example by extending the spindle 82 through the collar 84. The other end of the decelerator 130 fits snuggly inside the first roller 34, for example using a press fit. Alternatively, the decelerator 130 may interface with a groove or ridge on the inside of each roller.

FIG. 3 shows the window covering 11 according to the embodiment of FIG. 2 in a deployed position inside the frame 20, where the first sheet 30 and the second sheet 50 each cover substantially half of the window.

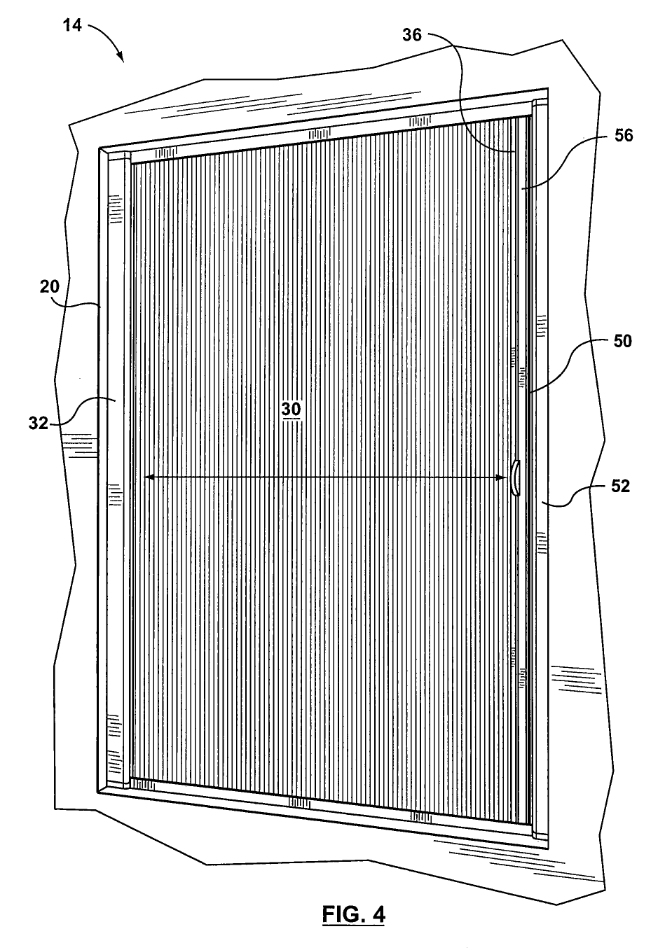

FIG. 4 shows the window covering 11 according to the embodiment of FIG. 2 inside a frame 20 in a deployed position, where the first sheet 30 covers substantially the entirety of the window.

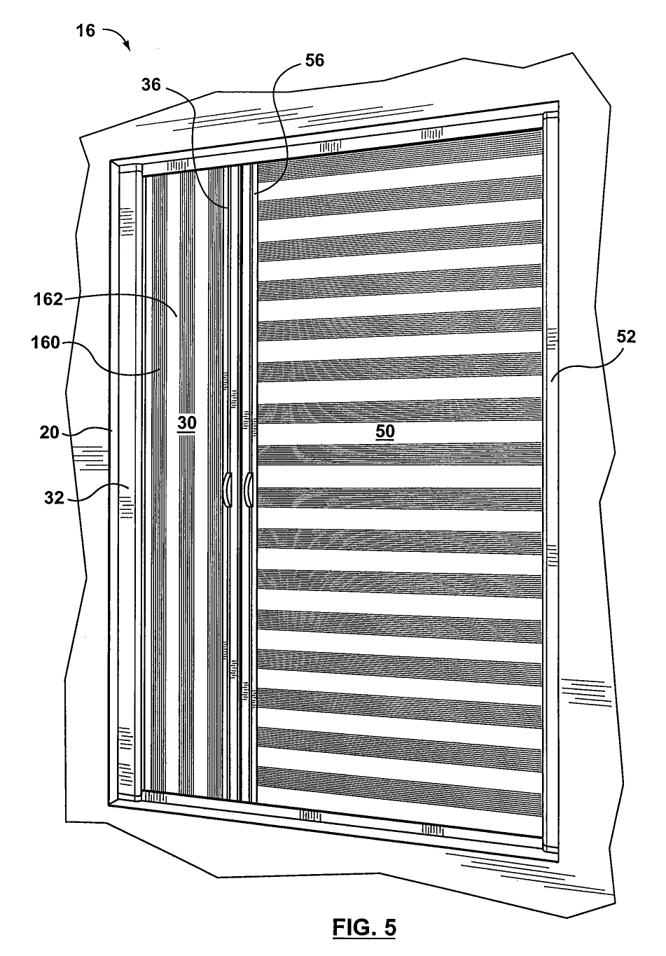

FIG. 5 shows the window covering 11 according to the embodiment of FIG. 2 inside a frame 20 in the deployed position, where the first sheet 30 covers about 25% of the window and the second sheet 50 covers about 75% of the window. The first sheet 30 shown in FIG. 5 includes alternating vertical strips of an opaque material 160 and a transparent material 162. The second sheet 50 shown in FIG. 5 is an opaque material.

As will be apparent to one skilled in the art, the proportion of the window that is covered by either the first sheet 30 or the second sheet 50 is arbitrary and may be adjusted by the user to suit his/her desires. Since both flexible sheets are dimensioned so that they are capable of covering the entire window alone, any proportional coverage desired is achievable: ranging from substantially complete coverage by the first sheet 30 to substantially complete coverage by the flexible sheet 50 and any combination therebetween.

In yet another alternative embodiment, the window covering 10 according to the embodiment of FIG. 1 or the window covering 11 according to the embodiment of FIG. 2 may be oriented vertically in the window such that the first and second sheets 30, 50 are unrolled from the top and bottom sides of the window, respectively. Otherwise, the window covering according to this embodiment operates in the same manner as described above.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A window covering for a window having a frame, the window covering comprising:
a. a first roller and a spaced-apart second roller, the first and second rollers rotatably mounted to the frame; and
b. a first sheet connected to the first roller and a second sheet connected to the second roller; each of the first and second sheets comprising: a pair of opposing side edges, a trailing edge, and a leading edge; the trailing edge being secured to the corresponding roller;
wherein the first and second sheets are each movable between a stowed position and a deployed position, wherein the first and second sheets are each coiled around the corresponding roller in the stowed position, wherein the leading edge is spaced apart from the corresponding roller in the deployed position;
wherein the first and second rollers are each adapted to bias the corresponding sheet toward the stowed position;
wherein the leading edge of the first sheet and the leading edge of the second sheet are adapted to make a removable connection therebetween to maintain the first and second sheets in the deployed position;
wherein at least a portion of the first sheet is adapted to permit more light to pass therethrough than the second sheet.

2. The window covering of claim 1 wherein the first and second rollers are positioned at opposite ends of the window frame.

3. The window covering of claim 2 wherein the first roller is positioned adjacent and parallel to the top of the window frame and the second roller is positioned adjacent and parallel to the bottom of the window frame.

4. The window covering of claim 2 wherein the first roller is positioned adjacent and parallel to the left side of the window frame and the second roller is positioned adjacent and parallel to the right side of the window frame.

5. The window covering of claim 2 wherein the first and second rollers and the first and second sheets are dimensioned so that substantially all of the window is covered when the leading edge of the first sheet is connected to the leading edge of the second sheet.

6. The window covering of claim 2 wherein the first sheet is dimensioned to substantially entirely cover the window when in the deployed position.

7. The window covering of claim 2 wherein the second sheet is dimensioned to substantially entirely cover the window when in the deployed position.

9. The window covering of claim 1 wherein the first sheet and the second sheet have different transparencies.

10. The window covering of claim 1 wherein the first sheet and the second sheet have different translucencies.

11. The window covering of claim 1 wherein the first sheet and the second sheet are made from different materials.

12. The window covering of claim 1 wherein at least one of the first sheet and the second sheet are made from plastic.

13. The window covering of claim 1 wherein at least one of the first sheet and the second sheet are made from fabric.

14. The window covering of claim 1 wherein at least one of the first sheet and the second sheet further comprises a printed design.

15. The window covering of claim 1 at least one of the first sheet and the second sheet comprises an alternating pattern of transparent and opaque horizontal strips.

16. The window covering of claim 14 wherein at least one of the first sheet and the second sheet comprises an alternating pattern of transparent and opaque vertical strips.

17. The window covering of claim 1 further comprising a spring mounted on the first roller, wherein the spring is adapted to bias the first sheet toward the stowed position.

18. The window covering of claim 1 further comprising a header connected to the leading edge of each of the first and second sheets.

19. The window covering of claim 18, further comprising a lock connected to the header of the first sheet, and an adjustable stop operatively connected to the frame, wherein the lock is adapted to engage the stop to removably secure the first sheet in place.

20. The window covering of claim 19, wherein the lock comprises a rod slidably connected to the header of the first sheet, and an actuator adapted to slide the rod, wherein the rod is adapted to slide transversely to the first sheet, wherein the rod is adapted to engage the stop.

21. The window covering of claim 17 further comprising a first decelerator coupled to the first roller, wherein the decelerator acts against the force of the spring.

22. The window covering of claim 18 further comprising a first magnetic strip connected to the header of the first sheet, and a second magnetic strip connected to the header of the second sheet, the first magnetic strip and the second magnetic strip being positioned to removably secure the header of the first sheet to the header of the second sheet.

23. The window covering of claim 18 further comprising a pair of spaced apart guide rails connected to the frame, wherein the guide rails receive opposing side edges of the first and second sheet to guide the first and second sheets during movement from the stowed position to the deployed position.

24. The window covering of claim 23 further comprising at least one wheel rotatably connected to the header of the first sheet, the at least one wheel adapted to engage the at least one guide rail to guide the first sheet during movement between the stowed position and the deployed position.
